(19) United States
(12) Patent Application Publication
(10) Pub. No.: US 2018/0111821 A1
(43) Pub. Date: Apr. 26, 2018

(54) AUTOMATIC MACHINE FOR INSERTING IN AN HOMOGENEOUS AND METERED MANNER INTO STUFFED ARTICLES OF VARIOUS KIND, IN PARTICULAR BUT NOT EXCLUSIVELY CLOTHES ARTICLES, OF STUFFING MATERIAL OF VARIOUS KIND SUCH AS FOR EXAMPLE POLYESTER FIBRES, PLUMAGE AND THE LIKE. ADAPTED TO MAINTAIN THE HEAT INTO THE SAME ARTICLES

(71) Applicant: B&B di Borsoi Michele, Vittorio Veneto (TV) (IT)

(72) Inventor: Michele BORSOI, Vittorio Veneto (TV) (IT)

(73) Assignee: B&B di Borsoi Michele, Vittorio Veneto (TV) (IT)

(21) Appl. No.: 15/560,816

(22) PCT Filed: Mar. 25, 2015
(86) PCT No.: PCT/IT2015/000080

§ 371 Date: Sep. 22, 2017

(51) Int. Cl. B68G 7/06; B68G 15/00; G01G 13/10; G01G 13/295; G01G 21/22

(52) U.S. Cl. CPC B68G 7/06; B68G 15/00; G01G 17/02; G01G 13/2958; G01G 21/22; G01G 13/10

(57) ABSTRACT

Automatic machine for inserting in an homogeneous and metered manner into stuffed articles of various kind, in particular but not exclusively clothes articles, of stuffing material of various kind such as polyester fibers, plumage and the like, adapted to maintain the heat into the same articles. Machine into which it is introduced the stuffing material contained into bags or containers provided by the producing and transforming firms of the same material, and such material is introduced and collected into a collecting and stocking container, from which the material is let to fall into underlying weighing containers communicating with the container, for weighing the material by loading cells, and the weighed material is subsequently transferred into an injection station adapted to insert and inject the same material into the pockets or spaces of each clothes article. There are described in detail the conformation of these component parts and the remaining operative component parts of the machine, as well as all the operations which are carried out for setting and controlling the different operative cycles of the machine.

The invention relates to an automatic machine for inserting in an homogeneous and metered manner into stuffed articles of various kind, in particular but not exclusively clothes articles, of stuffing material of various kind such as for example polyester fibres, plumage and the like, adapted to maintain the heat into the same articles.

There are known machines for inserting fibres, plumage or similar materials into stuffed articles of various kind such as for example clothes articles, for maintaining the heat into the same articles and so ensure and maintain an agreeable and steady temperature for the persons, wearing the same articles, above all under the wintry environmental conditions or anyway the low environmental temperatures. Such machines are made with a structure containing the stuffing material, into which the various working components are arranged, in which structure such stuffing material is introduced with such quantities as to fill several spaces or pockets for containing the same material, which are provided in the clothes articles.

The containing structure is also provided with suitable weighing devices, adapted to weigh the stuffing material being adequately conveyed from such containing structure and which, after the weighing operation, is delivered toward the machine components which are arranged for pushing and introducing the weighed stuffing material into the relative pockets or spaces of the clothes articles. However, the so realized machines for inserting the stuffing material have the following drawbacks:
not uniformly distribution of the stuffing material from the containing structure thereof toward the component pushing and introducing the material into the different pockets or spaces of the clothes articles, with consequent not homogeneous filling of the same material into such pockets or spaces;
difficult transfer of all the kinds of employed stuffing material from the machine containing structure toward the weighing devices of the same material;
not much precise and accurate weighing (tolerances not complying with the production standards), with consequent risk to introduce not correct quantities of material into the different pockets or spaces of the clothes articles;
possibility to have a not correct and/or defective operation of the component pushing and introducing the stuffing material from the containing structure toward the pockets or spaces of the clothes articles.

The object of present invention is to eliminate the drawbacks and applicative limits of the machines currently existing on the market, by means of a machine according to the present invention, adapted to insert automatically always in an homogeneous and correctly metered manner the stuffing material into the stuffed articles of various kind, and in particular but not exclusively into the clothes articles to be worn by the persons, for maintaining an optimum and comfortable heating temperature for the body thereof, above all in the cold periods of the year.

The invention will be better understood from the following description, given by way of not limitative example only, and with reference to the accompanying drawings in which:

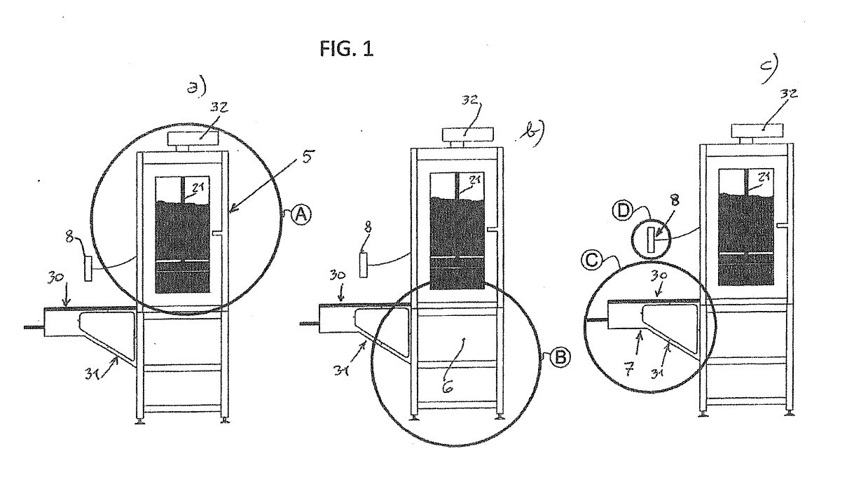

FIG. 1 shows a right and schematic side view of three automatic machines according to the invention, which are identical to each other, and any one of which puts in evidence some specific component parts of the same machine;

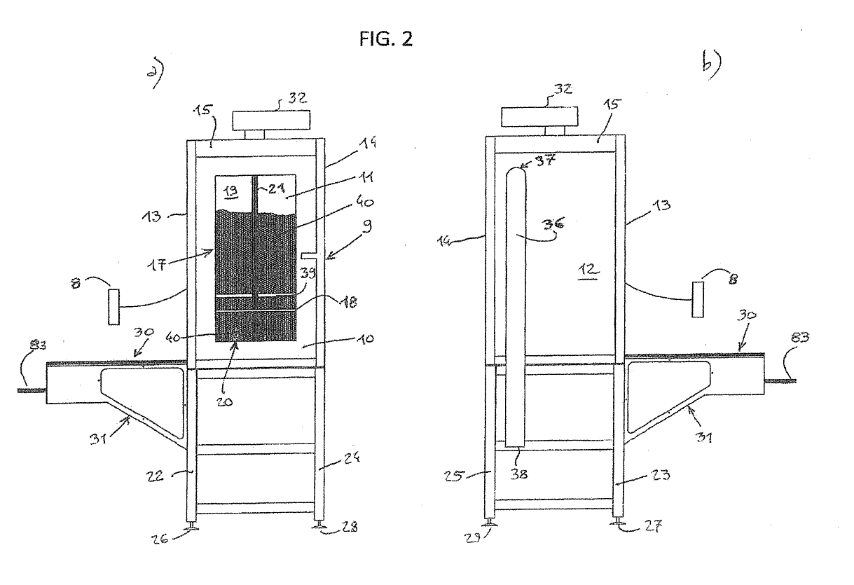

FIG. 2 a shows a right schematic and enlarged side view of the machine of FIG. 1;

FIG. 2 b shows a left side view of the same machine of FIG. 2 a;

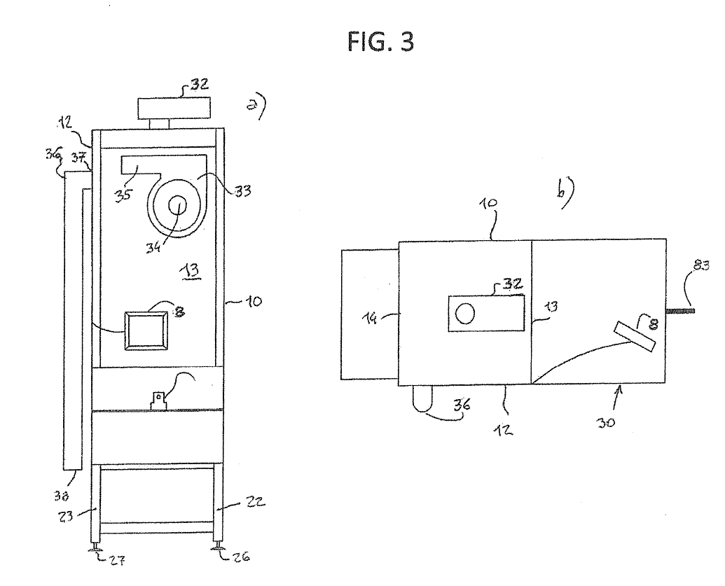

FIG. 3 a shows a front view of the present machine;

FIG. 3 b shows a plan view of the present machine;

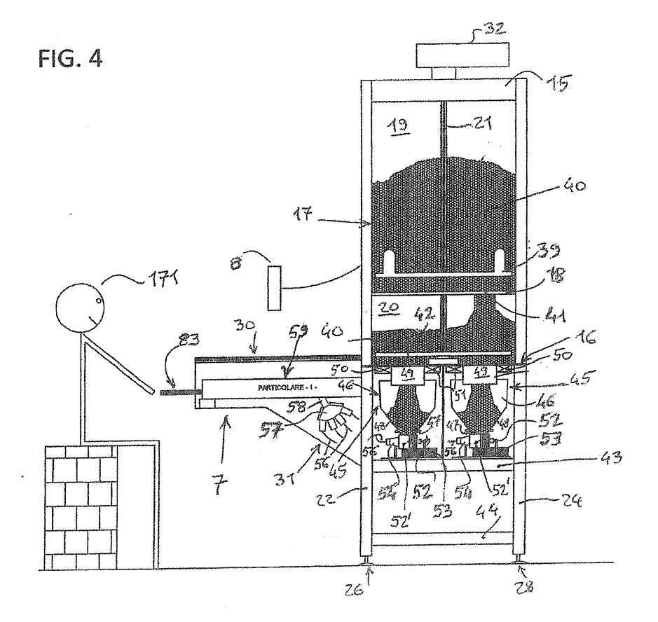

FIG. 4 shows a right and cutaway side view of the present machine, in which the main components of the same machine are put in evidence;

FIG. 5 shows a plan view of the machine cutaways in the weighing zone of the stuffing material;

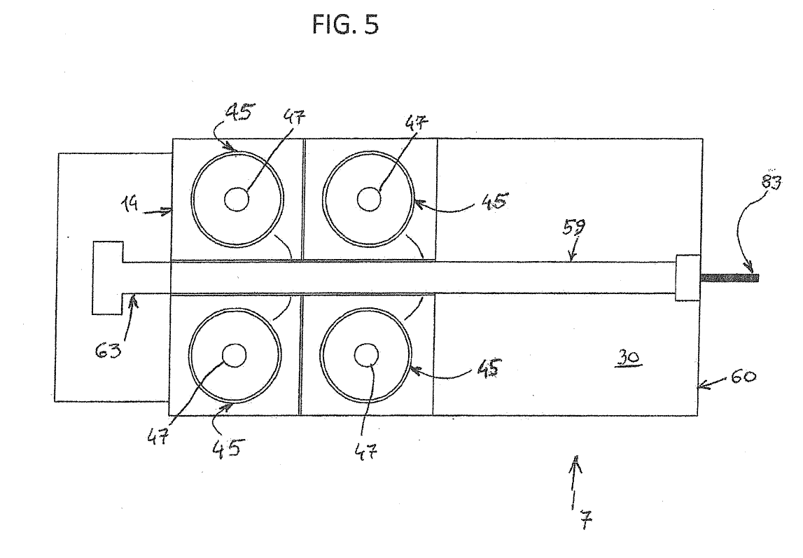

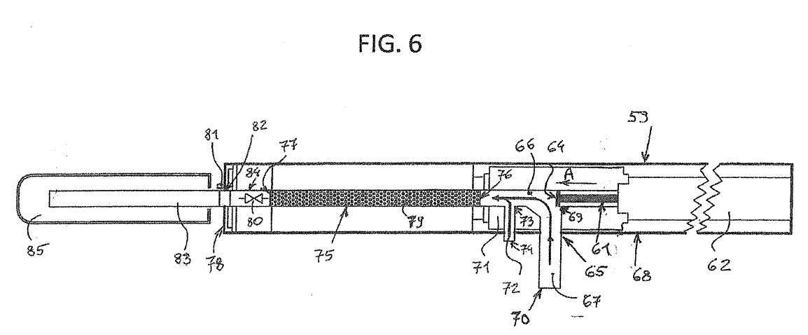

FIG. 6 shows a right and cutaway side view of a portion of the machine, in which there are arranged the component parts provided for the injection of the stuffing material into the pockets or spaces of the clothing articles;

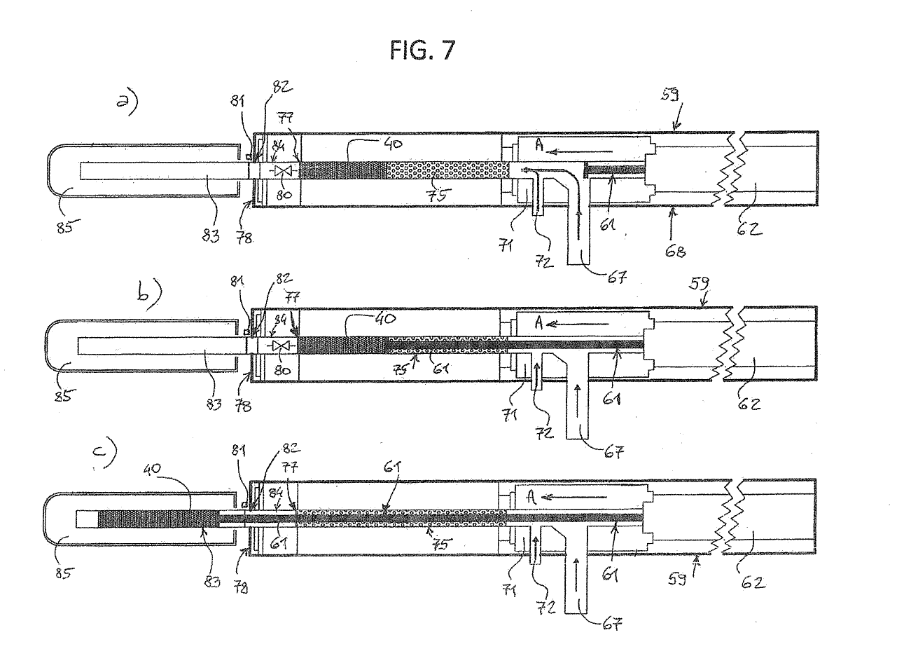

FIGS. 7 a, 7 b and 7 c show, with the same right and cutaway side view, the component parts of the FIG. 6 displaced into three different operative steps;

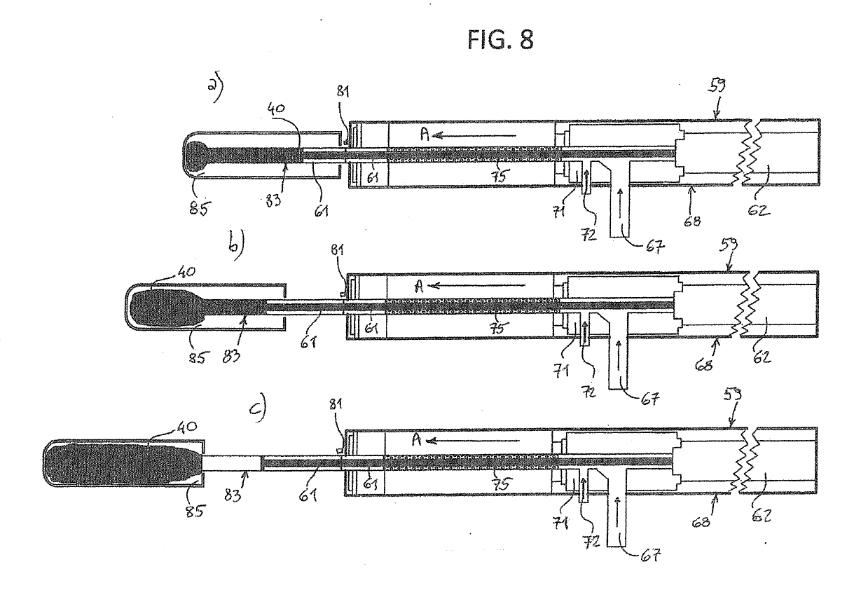

FIGS. 8 a, 8 b and 8 c show, with the same right and cutaway side view, the same component parts of the FIG. 6 displaced into three further operative steps;

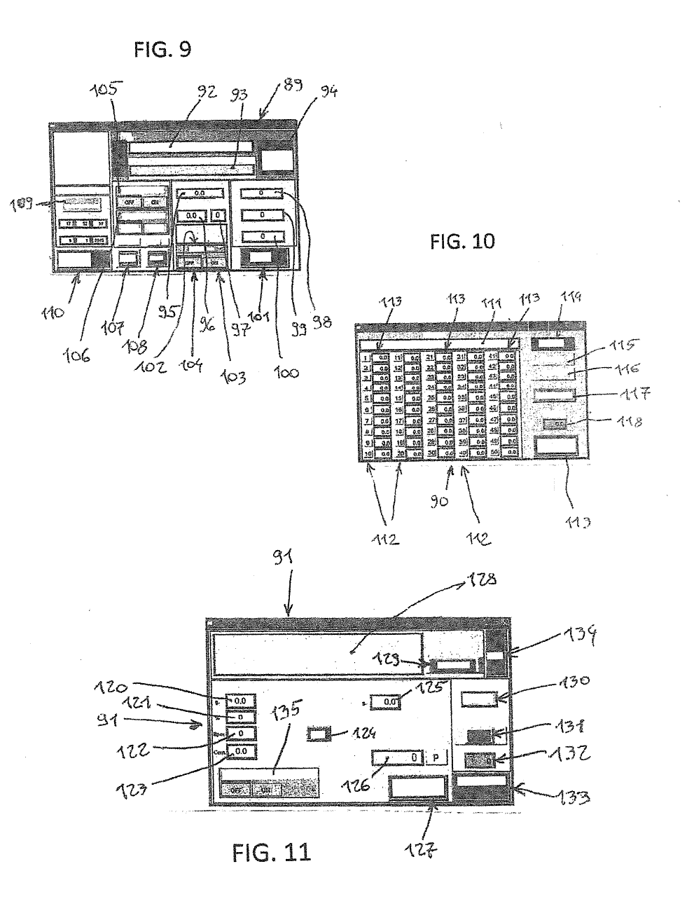

FIG. 9 shows a front view of the control panel of the machine operation with the windows with which there are indicated, set and displayed the operative programs of the present machine, as well as there are indicated the operative programs which may be set and displayed;

FIG. 10 shows a front view of a menu (or formula) of the above mentioned control panel, with the windows of the data to be set and displayed for one or more machine operative programs;

FIG. 11 shows a front view of another menu of the above mentioned control panel, with the windows for setting the various parameters of one or more machine operative programs;

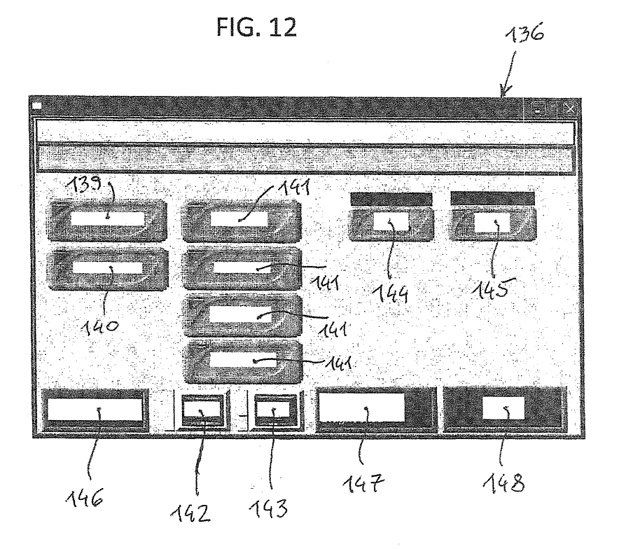

FIG. 12 shows a front view of still another menu of the above mentioned control panel, with the windows for the manual controls of the machine operative programs;

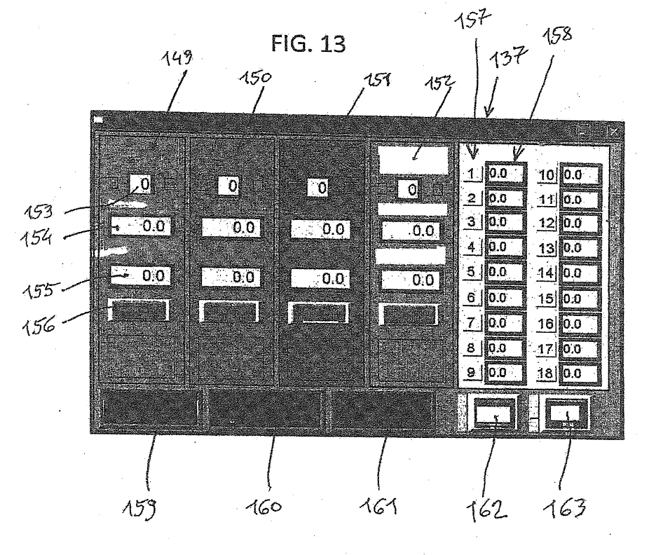

FIG. 13 shows a front view of still another menu of the above mentioned control panel, with the windows for the tests of the various programs which have been set;

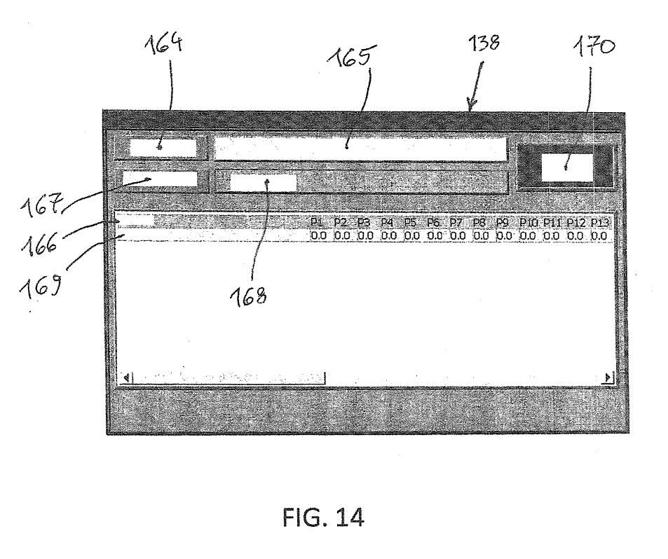

FIG. 14 shows a front view of still another menu of the above mentioned control panel, with the windows for looking for several formulas.

In the FIG. 1 there are illustrated schematically three machines identical to each other in accordance to the present invention, each one adapted to provide for the homogeneous and metered insertion into stuffed articles of various kind, in particular but not exclusively clothes articles, of stuffing material of various kind such as for example polyester fibres, plumage and the like, adapted to maintain the heat into the same articles.

From this FIG. 1, it is noted that in the FIG. 1 a it is put in evidence a machine component part, in this case the collecting and stocking container 5 of the stuffing material, which is marked with A; in the FIG. 1 b it is put in evidence another machine component part, in this case the weighing zone 6 in which the stuffing material is weighed, which is marked with B; while in the remaining FIG. 1 c there are put in evidence two further machine component parts, respectively the injection station 7 of the stuffing material into the different pockets or spaces of each clothes article, marked with C, and the machine control panel 8 containing the electronic control and regulating components for all the electric and electronic components of the machine, which is set with a particular software adapted to allow for to set, control and display the different operative programs of the machine, which will be hereinafter described with reference to the subsequent FIGS. 9, 10, 11, 12, 13 and 14. The present machine is substantially constituted by a metallic vertical structure 9 (see FIG. 2) of quadrangular shape, which is extended for a determinate height and in its upper part is formed by a first pair of vertical flat walls, having the same height, which are spaced away and parallel to each other and joined by angular section bars joined to each other (not indicated), which walls comprise a front wall 10 in which a transparent glass wall 11 having rectangular shape is included, and a back wall 12, and such structure upper part is also formed by a second pair of vertical flat walls having the same height, which are orthogonal to the previous walls and comprise a right side wall 13 and a left side wall 14, and all these walls are joined with an upper closing flat wall 15, shaped like a filtering grating for the scope which will be described, and with a lower closing flat wall 16 (see FIG. 4), thereby delimiting an inner closed room for containing and stocking the stuffing material 17, which is introduced into the same room as it will be described and is visible through the transparent front glass 11, into which inner room a horizontal separating inner plane 18 is fixed for the entire extent thereof, and is adapted to subdivide the same room into two separated chambers, respectively an upper chamber 19 having a larger volume and a lower chamber 20 having smaller volume, which chambers are provided for the grounds which will be described. A rotating vertical shaft 21 is also supported in the upper part by a reduction gear (not indicated) mounted in the central part of the upper filtering grating 15 of the machine, and extends for the entire height of both the chambers 19 and 20 and is supported in the lower part by a bearing (not shown) mounted in the central part of the lower closing wall 16 of the machine. In its lower part, the structure 9 is formed by a set of four vertical legs 22, 23, 24 and 25, having the same height, constituted by relative metallic section bars which are extended in the lower part from the correspondent front, back and side walls, and in the lower end portions of which there can be screwed and screwed off correspondent support and regulating legs 26, 27, 28 and 29 laying on to the floor.

The machine is also constituted by a horizontal projected part 30 fixed overhung, by means of a suitable support structure 31, on to both the right side wall 13 and the lower legs 22 and 23 of the machine structure, and on to which there are installed the components of the machine injection station 7.

Finally, the machine is constituted by the control panel 8 which is mounted on and supported by the right side wall 13. As visible particularly from the FIGS. 2 and 3, the machine comprises also an agitator motor 32 mounted on and secured to the central part of the upper filtrating grating 15, and supplied by an electric cable (not shown), as well as positioned coinciding with the rotating vertical shaft 21, to which it is connected through the relative reduction gear, to provide for a relative rotation and agitation of the same shaft in a pre-established fixed rotation direction, with a slow and continuous rotation speed, for the scope hereinafter described. Further characteristics and components of the present machine are shown in the FIGS. 2, 3 and 4, from which it is noted that such machine is also provided with a sucking system of the stuffing material, which is loaded by the production and transforming Firms into bags or other suitable containers (not shown), with high containing volume, which are supplied to the operators of the machine referred to for transferring such stuffing material from such bags or containers into the containing and stocking room 17 of the machine. The sucking system is substantially constituted by at least a conventional exhaust fan 33, mounted on and secured in the upper part to the machine front wall 13 and provided with an air outlet hole 35 and a sucking pipe fitting 34. The machine is also provided with a lengthened flexible conduit 36, for sucking and passing the stuffing material, the upper end portion 37 of which is introduced through a correspondent through hole (not indicated) of the back wall 12 of the machine vertical structure 9, therefore being supported by such back wall in a manner that under the normal condition such conduit 37 be freely and vertically swinging along the same back wall, for almost its height, as visible in the FIGS. 2 b) and 3 a). In turn, such upper end portion 37 of the conduit 36 terminates in the interior of the upper chamber 19 of the containing and stocking room 17 of the machine, and is also connected to the sucking pipe fitting 34 of the exhaust fan 33.

When it is necessary to transfer the stuffing material from a bag or container into which it is contained into the above mentioned machine upper chamber 19, the operator grasps the flexible conduit 36 and introduces the free end portion 38 of the same conduit into the stuffing material contained in the bag or container, then he actuates the exhaust fan 33 which therefore provides for sucking such material from the free end portion 38 of the conduit 36, by letting it to pass through the entire same conduit and so introducing this stuffing material into the machine upper chamber 9.

During this sucking step, while this upper chamber 19 fills it progressively with the stuffing material, the air contained in the same chamber is extracted outwards through the upper filtrating grating 15, for facilitating the loading of the stuffing material in the interior of the same upper chamber, and the air sucked through the exhaust fan 33 is also discharged through the outlet hole 35 of the same exhaust fan, and is filtered by passing through some filters (not shown) included into said exhaust fan. When the required quantity of stuffing material has been sucked, which is transferred into the above mentioned upper chamber 19, the operator stops the operation of the exhaust fan 33, and thereby the machine is arranged for performing the operative cycles for introducing such stuffing material into the various pockets or spaces for containing the different stuffed clothes articles. Moreover, the machine comprises at least a thin horizontal rectilinear blade 39 secured to the rotating vertical shaft 21 in the lower zone of the upper chamber 19 for containing the stuffing material 40 being introduced into the same chamber as described above, such horizontal blade 39 having a length slightly smaller than the width of the upper chamber 19, in a manner to allow the same blade to rotate when the agitator rotating shaft 21 is actuated in rotation. On to the horizontal inner plane 18 of the machine which, as already specified, separates the upper chamber 19 from the lower chamber 20 of the machine, it is provided a vertical through hole 41 which puts into communication both the chambers 19 and 20, thereby permitting the discharge of the stuffing material 40 from the upper chamber to the lower chamber, and the presence of these two chambers separated and overlapped to each other serves to prevent that, in the case of a single chamber, the same be loaded excessively with stuffing material and therefore should stands a high weight of the same material.

On the contrary, with the solution of the two separated chambers, the weight of the material is distributed on to both the chambers, and therefore the fall of the material in to the weighing system is more controlled.

During its rotation by means of the vertical rotating shaft 21, the horizontal blade 39 provides for a continuous agitation in the upper chamber 19 of the stuffing material 40, and a progressive and controlled fall of the same material toward the underlying lower chamber 20, by passing through the vertical through hole 41. Also in the lower chamber 20 a horizontal rectilinear blade 42 is provided, which is fixed to the rotating shaft 21 in the lower zone of the lower chamber 20 and having a length slightly smaller than the width of the lower chamber 20, in a manner to allow the same blade to rotate, together with the upper blade 39, when the agitator rotating shaft 21 is actuated in rotation.

Also this further rotating blade 42 is provided for performing the same function of the preceding blade, and for discharging as it will be described the stuffing material 40 contained into the lower chamber 20 toward the underlying weighing zone of the stuffing material, which is separated from the lower chamber 20 and is made and performs the function which will be hereinafter described. To this aim, as particularly visible from the FIG. 4, the vertical legs 22, 23, 24 and 25 of the machine are joined to each other by a first set of horizontal section bars 43, secured at about the half height of the same legs, and constituting a horizontal plane for supporting the components of the weighing zone, which are formed by collecting and weighing devices of the stuffing material, which will be described later on, the vertical legs being also joined to each other by a second set of horizontal section bars 44, situated below the section bars 43 and in the lower part of the same legs, in order to stiffen and strengthen the entire structure, together with the section bars 43.

The weighing zone of the stuffing material is delimited by the space comprised between the machine lower closing wall 16 and the underlying horizontal support plane formed by the horizontal section bars 43, and the components of the weighing zone are the following:

1) a set of containers for collecting the stuffing material, in the example constituted by 4 containers for weighing the same material, which are identical to each other and are marked with the reference numeral 45.

The weighing and collecting system 45 is formed by a vertical receptacle having such a loading volume as to be able to collect the stuffing material with a quantity enough to fill at least a pocket or space of the clothes article, and such receptacle is shaped with an upper cylindrical part 46 having larger diameter, which is tapered downward by forming a lower cylindrical part 47 having smaller diameter, in a manner that the stuffing material loaded in the upper cylindrical part 46 goes down easily downward, by sliding along the inclined cylindrical wall 48 of the receptacle, up to arrive in the lower cylindrical part 47. The weighing containers 45 are mounted spaced away from each other, with an uniform distribution on to the horizontal support plane formed by the section bars 43, and operate and are loaded with stuffing material in a manner independent to each other.

2) A set of hollow trapdoors 49, in the example of rectangular shape, constituted by 4 trapdoors equal to each other, arranged in a position interposed between the upper cylindrical part 46 of each weighing container 45 and a relative through hole (not indicated), provided through the lower closing wall 16 of the machine, wherein the upper wall (not indicated) of each trapdoor 49 is open and into close contact with the relative through hole of the lower closing wall 16, while the lower wall (not indicated) of each trapdoor 49 is also open and passes through a correspondent through opening (not indicated) of the upper cylindrical part 46 of the relative weighing container, entering slightly the same container.

The scope of the trapdoor 49 of each weighing container is to permit the introduction of the stuffing material 40, contained into the machine lower chamber 20, in the underlying weighing container, in pre-established metered quantities thereof, and provided for filling one or more pockets or spaces of the clothes article. In order to permit this introduction of the stuffing material in the respectively pre-established quantity, each trapdoor 49 is provided with suitable movable means such as for example two pneumatic cylinders 50 and 51 and two gates (not indicated) disposed closer to the open upper wall of the trapdoor 49, in a position aligned to each other and which can be actuated by means of the relative pneumatic cylinders 50 and 51, connected in the machine pneumatic circuit and controlled by the software system of the machine, such pneumatic cylinders and gates being able to be actuated from a closed position in which they are into contact between them and prevent the passage by fall of the stuffing material from the lower chamber 20 to the trapdoor 49 and from this latter into the relative weighing container, to an opened position in which the pneumatic cylinders and the gates are moved away from each other and allows the passage by fall of the stuffing material in the relative weighing container, by passing through the trapdoor 49.

3) A set of air bellows 52, in the example constituted by 4 bellows identical to each other and shaped with hollow cylindrical form, which are installed into the cylindrical connecting collector 52′ of the weighing container 45 with the underlying loading cell 53 (which will be described hereinafter), in order to facilitate the suction of such material toward a specific collector 54, fixed in front of each bellows 52 and shaped with a cylindrical form tapered from the bellows outwards, which collector serves to convey the stuffing material collected into and weighed by the loading cell 53 toward the machine injection station 7, in the manner which will be described.

4) Loading cell 53, in the example constituted by four elements identical to each other, and applied in a position interposed between the closed lower wall (not indicated) of each air bellows 52 and the horizontal support plane formed by the section bars 43, from which plane such loading cell 53 is supported.

Each loading cell 53 is formed by an electric or electronic sensor, a balance or the like, adapted to detect the weight of the stuffing material contained into the relative weighing container and to generate electric or electronic signals correspondent to the weight detected from time to time, which signals are transmitted through the machine electric circuit to the main control device of the same machine, included into the machine control panel 8, which provides for recognizing the same signals and to indicate the correspondent weight which has been measured. In this case, the different loading cells 53 are calibrated in advance, by acting on to the machine control panel 8, in a way to fill each weighing container 45 with the quantities respectively desired of the stuffing material. To this purpose, such loading cell 53 of each weighing container 45 is connected to the pistons and the gates of the relative trapdoors 49 and, at the beginning of the weighing operation, it controls such pneumatic cylinders 50 and 51 in such a way as to keep such pistons and gates moved away from each other, thereby permitting the loading of the stuffing material from the underlying chamber 20 to the weighing container.

When such weighing container has been filled with the requested quantity of stuffing material, the weight of which is detected by the relative loading cell 53, this latter provides for determining the displacement of the pistons and gates in an approached position, thereby closing the passage for the stuffing material and terminating the filling of the weighing container.

The collectors 54 of each weighing container are connected through relative conduits 56, intercepted by correspondent pneumatic control valves (not indicated) connected to a pneumatic circuit of the machine and controlled by the main control device included in the machine control panel 8, with a central collector 57 (see FIG. 4) mounted into the injection station 7 of the machine, in such a way that the stuffing material introduced into the weighing container may be sucked through the collector 54 of any one of the weighing containers, with the aid of the relative air bellows 52, and may be conveyed to the central collector 57 by passing through a relative conduit 56, when the correspondent pneumatic valve connected to such conduit has been actuated from the normally closed position to the opened position thereof, thereby permitting the passage of the stuffing material from such weighing container to the central collector 57. In this manner, the stuffing material is always conveyed from a weighing container at a time to the central collector 57, and from this latter it is conveyed to the injection station 7, through a conduit 58 communicating with the components of the same injection station, and from this injection station the stuffing material is then injected into the pocket or space of the clothes article adapted to contain this volume of the stuffing material, and such conveying is always obtained by actuating from time to time into the opened position the pneumatic valve associated with such weighing container.

The suction of the stuffing material by each collector 54, which passes through the relative pneumatic valve which is opened, is obtained by a compressed air supply line to which the machine is connected, with the aid of a specific suction device (not shown) made as it will be described and connected into the injection station 7. The injection station 7 of the machine of the relative components mounted therein is now described in detail, together with the operation of the same components for providing for the injection of the stuffing material into the pockets or spaces of each clothes article.

In the FIG. 6 there are now described the different components of the machine provided for the injection the stuffing material, while in the FIGS. 7-8 there are described the various operative steps of the components of the injection station which are foreseen for conveying and injecting the stuffing material into the clothes article. In the FIG. 5 it is shown a plan view of the four weighing containers 45 of the machine weighing zone, which have been already described previously, together with the injection station 7, into which a lengthened rectilinear tubular conduit 59 is incorporated, which extends in the axial and central direction of both the injection station 7 and the free space delimited by the four weighing containers 45, which conduit serves to house the components which will be described in the subsequent FIG. 6 and is lengthened from the back side wall 14 of the machine up to the transversal terminal wall 60 of the injection station 7. By referring now to the FIG. 6, it is shown the tubular conduit 59 with the relative components included in its interior. Such components are substantially constituted by:

1) a lengthened rectilinear linear actuator 61, having cylindrical section with reduced thickness, which is housed into a lengthened piece 62 fixed between the weighing containers, and slidable in the alternate direction into the same piece, such actuator being fixed with an end portion to an electric motor 63 (see the FIG. 5) connected to the machine electric circuit and provided for actuating the actuator in the alternate longitudinal direction, which motor is controlled by the machine main control device, incorporated into the control panel 8. In turn, the other end portion of the linear actuator 61 is shaped with an enlarged disc 64, adapted to slide in the alternate longitudinal rectilinear direction in the interior of correspondent cylindrical elements which will be described later on. The so realized actuator may therefore slide from a retracted position thereof, visible in the FIG. 6, in which the stuffing material finds it in the loading step into the weighing containers, and has not yet been introduced or has just been introduced into the components housed into the tubular conduit 59, to a working position thereof fully extracted from the tubular conduit 59 (see FIG. 8 c), for injecting the stuffing material into the pockets or spaces of each clothes article, with the operative steps which will be described.

2) A filling collector 65 having tubular shape, adapted to introduce the stuffing material coming from the central collector 57 into an inner cavity 66 of the tubular conduit 59, provided in front of the linear actuator 61 displaced in the rest position thereof. Such filling collector 65 is shaped with a short tubular conduit 67, passing orthogonally through the peripheral wall 68 of the tubular conduit 59 and communicating with its internal end portion 69 with the inner cavity 66 and joined with its external end portion 70 with the conduit 58 of the central collector 57.

3) A flow amplifier 71 constituted by a short tubular conduit 72, having a section smaller with respect to the previous tubular conduit 67 and passing orthogonally through the peripheral wall 68 of the tubular conduit 59 and communicating with its inner end portion 73 with the inner cavity 66, at a position closer to the previous tubular conduit 67, downstream the linear actuator 61 in its sliding direction A during the injection step of the stuffing material. Such tubular conduit 72 is joined with its outer end portion 74 to the compressed air supply line of the machine (not shown), in such a way that when the compressed air is supplied through the tubular conduit 72, this latter provides for a correspondent suction of the air through the previous tubular conduit 67, which owing to the Coandà physical effect as operation principle of the flow amplifier, increases the air flow rate, namely for each unit of sucked air it is created a final multiple air flow rate, in this case of four times greater. The so produced air suction into the tubular conduit 67 provides for a consequent greater suction force for the time unit of the stuffing material from the collector 54 of the weighing container 45, and such material is conveyed at first into the central collector 57, by passing through the relative conduit 56 the pneumatic valve of which has been actuated into the opened position, and thereafter from this central collector 57 the same material is conveyed into the inner cavity 66 of the tubular conduit 59, by passing through the conduit 67, and from such inner cavity 66 the material is conveyed into the subsequent component, which is constituted by the lengthened cylindrical reservoir 75 which will be described later on. Under this condition, the machine is arranged for the injection of the stuffing material into the pockets or spaces of the clothes article, while the linear actuator 61 is displaced into the retracted rest position thereof of the FIG. 6.

4) A lengthened rectilinear perforated cylindrical reservoir 75, housed into the tubular conduit 59 and having a diameter smaller than that of this conduit, which has an end portion 76 arranged into the inner cavity 66 and the other end portion 77 which is situated slightly spaced away from the terminal flat wall 78 of the tubular conduit 59. Such cylindrical reservoir 75 is provided for the entire length thereof with an inner through hole (not indicated) having a diameter slightly larger than the disc 64 of the linear actuator 61, in order to allow the alternate sliding of this latter, in a way that during the injection step such disc 64 of the actuator 61 by sliding through such inner through hole pushes progressively the sucked stuffing material along the entire cylindrical reservoir 75. In turn, the cylindrical reservoir 75 is made with a completely perforated surface, and these holes 79 have the function to discharge externally the air produced during the loading step of the stuffing material into the same reservoir, in order to empty completely the pre-load of the material into the weighing containers 45. In this manner, the stuffing material being sucked from each collector 54 passes through the central collector 57, the inner cavity 66 and enters the cylindrical reservoir 75 up to the end portion 77 of the same reservoir, which is kept closed as it will be described.

The duration of the loading step of the stuffing material into the cylindrical reservoir 75 occurs within a pre-established time, and such duration is controlled by the main control device incorporated into the control panel 8, and is set by the constructor.

5) An intercepting valve 80 mounted in the interior of the tubular conduit 59, in a position comprised between the relative end portion 77 of the cylindrical reservoir 75 and the terminal flat wall 78 of this latter. Such valve 80 is connected in the machine electrical circuit and controlled by said main control device, from an opened position to a closed position thereof, and vice versa.

This valve 80 is also connected with the terminal end portion 77 of the cylindrical reservoir 75 and, when it is actuated in the closed position thereof, it remains in this position by keeping closed also the terminal end portion 77, and under this condition the stuffing material may be loaded into the cylindrical reservoir 75 up to the closed terminal end portion 77, while the linear actuator 61 is displaced into its retracted rest position of the FIG. 6.

When all the stuffing material 40 has been loaded into the cylindrical reservoir 75, an the end of the duration of the loading step, the linear actuator 61 is still displaced into its retracted rest position (see FIG. 7 a) and the machine is arranged for starting the injection step of the stuffing material.

The injection station 7 also comprises an electronic presence sensor 81 (see FIGS. 6-8), connected to a timer and in the machine electric circuit, for displaying the injection message OK when the stuffing material is arrived at the adjacent end portion of a hollow injector 83, associated with the tubular conduit 59 as it will be described. Finally, the machine also comprises a hollow injector 83, external to the tubular conduit 59 and formed by a rectilinear pipe disposed in a position aligned and coincident with a through hole 82 of the tubular conduit 59 and having the same diameter of the cylindrical reservoir 75, such hollow pipe 83 being joined to a short cylindrical conduit 84, into which the valve 80 is housed, and which is joined to the end portion 77 of the cylindrical reservoir 75 and passes through the through hole 82, and is slightly projected outward the tubular conduit 59.

The scope of the hollow injector 83 is to inject the stuffing material, coming from the cylindrical reservoir 75 and pushed by the linear actuator 61, respectively into a pocket or space 85 of a clothes article.

In the FIGS. 7-8 it is now described the machine operation for determining the injection of the stuffing material loaded into the cylindrical reservoir 75 into the pocket or space 85 of the clothes article. In the FIG. 7 a) it is noted that the stuffing material 40 finds it in the loading step into the cylindrical reservoir 75, and is stopped against the terminal wall 77 of this latter, while the linear actuator 61 is still displaced in the retracted rest position thereof.

In the FIG. 7 b it is noted that at the end of the time regulated loading step of the stuffing material 40 into the cylindrical reservoir 75, this condition is detected by the main control device of the machine, which provides for actuating both the valve 80 into the opened position thereof and the electric motor 63 (see FIG. 5), and therefore the linear actuator 61 too, in the advancing direction A with a continuous advancement, and in this case it is noted that the actuator 61 is arrived into contact with the stuffing material 40 and continues to push this material in the direction A. The starting of the sliding of the linear actuator 61 is determined subsequently the loading of the reservoir 75, namely after the time pre-established empirically by the constructor for loading the same reservoir. In the subsequent step of the FIG. 7 c), it is noted that the linear actuator 61 is advanced beyond the tubular conduit 59 and begins to push the stuffing material 40 into the inner cavity of the injector 83 and the material being passed through the through hole 82 of the tubular conduit 59 is detected by the electronic presence sensor 81, which signals such presence of the material to the main control device of the machine and communicates to the linear actuator 61 to continue the advancing movement in order that the same material arrives to the opposite end portion of the injector 83.

The distance between the sensor 81 and the opposite end portion of the injector 83 is determined by a time established by the machine operator.

In the subsequent injection steps of the FIGS. 8 a) and 8 b), it is noted that the linear actuator 61 continues to advance in the direction A, by pushing progressively the stuffing material 40 along the injector 83, up to the end of the same injector and, when the stuffing material is arrived to the opposite end portion of the injector 83, it starts the injection operation of the same material into the pocket or space 85 of the clothes article. In the subsequent terminal injection step of the FIG. 8 c), it is noted that the material has been completely pushed beyond the injector 83, and has filled completely in an homogeneous and uniform manner the pocket or space 85 of the clothes article.

The back movement of the linear actuator 61 is controlled by the sensor 86, which detects the end-of-stroke position thereof. Such sensor 86 is positioned behind the end portion of the actuator 61. As soon as the actuator 61 is returned back into its rest position, this condition is detected by the electronic sensor 86 signalling this condition to the main control device, which provides for stopping the movement of the linear actuator 61, thereby arranging the machine for performing a subsequent injection cycle of the stuffing material into another pocket or space of the clothes article referred to or of another clothes article, and which cycle will be performed with the same operative steps as described.

Now, there are described the various parameters and the touch sensitive selector keys for the operative programs which may be selected by acting on to the virtual pages visible on to the machine control panel 8.

Such parameters of the programs are visible in the FIG. 9, in which it is shown the main virtual page 89 of the operative programs included into the software of the machine, in the FIG. 10 in which it is shown the virtual page “formula” 90, in the FIG. 11 in which it is shown the virtual page for setting the parameters 91 of the different operative programs that the machine can perform, in the FIG. 12 in which it is shown the virtual page for the manual controls of the machine operative programs, in the FIG. 13 in which it is shown the virtual page for seeing the operation of each single balance during the weighing step, and the FIG. 14 in which it is shown the virtual page for looking for several formula.

In the main page 89 there are put in evidence the main operative controls, while in the page 90 it is defined the filling cycle (“formula”), and in the page 91, on the contrary, there are defined some other parameters for improving the machine performances, based on the type of work which must be performed. In the page 89 there are visible the following windows:

windows 92 indicating the name of the formula in the search step (see FIG. 14); windows 93 indicating the formula in the working step of the clothes article indicated in the windows 92; windows 94 indicating the touch sensitive selector for opening the page “search formula” (see FIG. 14), where all the programmed formula are inserted; windows 95 indicating the established weight during the programming of the formula for each single weighing operation; windows 96 indicating the actually measured weight of the loaded stuffing material based on to the programmed weight visible in the windows 95; windows 97 indicating the number of the relative weighing operation of the respectively programmed material and visible in the windows 112; windows 98 indicating how many times the same formula must be repeated; windows 99 indicating the number of the already effected formula; windows 100 indicating the number of the initial weighing operation from which the machine starts the filling step, namely one can establish from which weighing operation the filling cycle must initiate in the case in which it is necessary to take again the weighing operations after an incidental interruption during working; windows 101: by pushing this windows, the page 90 is displayed where the formula are created, changed and erased; windows 102, titled emptying, indicating the control for starting the emptying of the weighing containers 45 in the case in which an incidental interruption of the machine operation occurs and each time the same machine is re-started; windows 103 indicating the switch for controlling the start of the emptying step as above described; windows 104 indicating the switch for controlling the end of the emptying step as above described; windows 105 indicating the control for actuating the exhaust fan 33, for sucking the stuffing material from the bags into which it is contained and introducing the same material into the machine. Below such windows, with “ON” is indicated the control for starting the exhaust fan operation and with “OFF” is indicated the control for disconnecting the exhaust fan; windows 106, defined manual/automatic, which indicates, in the case of manual operation, the weighing operation relative to the correspondent number of the formula being performed as indicated in the windows 93; in the case of automatic mode, it indicates the carrying out of the entire selected filling cycle; the windows 107 indicates the switch for starting the filling cycle; the windows 108 indicates the switch for terminating the selected filling cycle, in the case in which it is necessary to interrupt the filling cycle for various grounds; the windows 109 indicates the switch for selecting the language to be used (Italian, English, German etc. . . . ), and below such windows there are respectively indicated the time and the date in general; the windows 110 (parameters and diagnostic) indicates the control for displaying the page of the FIG. 11. In the FIG. 10 it is now shown the virtual page “formula” 90, into which the following windows are included:

windows 111 indicating the name of the “formula” to be used, which is also indicated in the windows 92 of the main page 89 (see FIG. 9); windows 112, indicating with progressive numbers the different weighing operations of the stuffing material into the correspondent weighing containers; windows 113 overlapped to each other into more rows, indicating the weight of the respective quantities of the stuffing material to be loaded into the correspondent weighing containers, which material will be injected into the different pockets or spaces of one or more clothes articles. The formula foresees at the most 50 weighing operations, namely the standard formula includes 50 weighing operations, of which only those of interest will be filled in. In the virtual page “formula” 90 there are also included the following windows:

windows 114 (search) indicating the touch sensitive selector for displaying the virtual page indicated in the FIG. 14, where all the programmed formula may be seen; windows 115 (new) indicating the touch sensitive selector for setting a new formula with the same parameters or with different parameters, and relating to one or more clothes articles to be stuffed; windows 116 (to save) indicating the touch sensitive selector for storing each new formula which has been selected or each new change of the existing formula.

Each formula which has been set is found by acting on to the touch sensitive selector 94 of the main page 89 (see FIG. 9), which opens the virtual page of the FIG. 14; windows 117 (to erase) indicating the touch sensitive selector for erasing the formula selected by the control “to look for the formula” (FIG. 14); windows 118 (max. load) indicating the maximum weight of the stuffing material which may be loaded into the relative weighing containers; windows 119 indicating the touch sensitive selector for returning back from the page “formula” to the “main page” 89.

By referring now to the FIG. 11 concerning the virtual page 91 of setting the different operative programs of the machine, it is noted that below the writing “parameters setting” there are visible the following windows, the function of which will be in short described:

1) windows 120 (flying weight) indicating the parameter concerning the quantity of stuffing material (polyester fibre, plumage or the like) provided in the zone comprised between the lower separating plane 16 of the lower chamber 20 and the lower cylindrical part 47 of the weighing container (see FIG. 4) at the moment in which, during the step for transferring through the relative trapdoor 49 of the material from the lower chamber 20 toward the relative underlying weighing container, such trapdoor is closed so as to interrupt the fall of the stuffing material. This parameter has been foreseen, in that in this zone a quantity of stuffing material will be always provided, from the moment in which the loading cell 53 detects the “programmed weight” in the page “formula” to the moment in which the relative trapdoor is closed, which interrupts the fall of the material. Under this condition, during the loading step into the weighing container, in the machine operative program it will be always established empirically the quantity of stuffing material still present into such zone, which may vary for example from 0.1 g. to about 0.3 g., and this quantity of material, defined as “flying weight” will be considered at the moment of the weighing operation of the material loaded into the weighing container. If, after having effected some weighing cycles, it is detected a steady miscalculation of the values of the weighing operations, namely the “detected weight”, visible in the windows 96 of the main page 89, is steadily greater than the “programmed weight” value, visible in the window 95 of the same main page 89, for example it is of 0.1 g., it is possible to interfere with the parameter “flying weight”, by inserting in the windows 120 of the “flying weight” the value correspondent to the exceeding quantity of stuffing material (in the example, of 0.1 g.), and in this way the main control device of the machine is arranged for anticipating the closing of the relative trapdoor 49 for transferring the material from the lower chamber 20 to the weighing container, and such anticipated closing of the trapdoor occurs depending on the inserted value of “flying weight”.

2) Windows 121 (“speed slow weight”) indicating the value of the rotating speed of the agitating rotating blade 42 (see FIG. 4), which is actuated with two different speeds, the initial faster one, and a subsequent slower one (“speed slow weight”). The faster speed is performed in the first step for transferring the stuffing material from the upper chamber 19 to the lower chamber 20.

In turn, the subsequent slower speed (speed slow weight”) is performed in the final part for transferring from the lower chamber 20 to the relative weighing container, and this speed may be changed by the operator, in that by changing this parameter it is possible to slow down the transfer of the material to be weighed in the final part of loading the weighing container, with consequent greater accuracy of metering the material during the weighing operation thereof. Against this, the material weighing process occurs in a slower way with a relative slower productive capacity per hour.

3) Windows 122 (“injection speed”): this parameter indicates the ejection speed of the stuffing material from the injector 83, namely it is the advancing speed of the linear actuator 61.

4) Windows 123 (injection advancement time) indicating the time, determined empirically by the operator, employed by the fibre for running through the space from the sensor 81 to the opposite end portion of the injector 83, in such a way that the fibre goes out immediately from the end portion of the injector when the injection step into the piece to be filled is started, and this fact is provided for having no displacement of the article to be filled if the material isn't yet arrived to the opposite end portion of the injector.

5) Windows 124 (to save) indicating the touch sensitive selector for saving in to the memory of the main control device of the machine the data which have been set and are visible in the windows 122 and 123.

6) Windows 125 (max. weight) indicating the maximum weight of the stuffing material loaded for each weighing operation, in such a way that it is prevented to the operator to insert values greater to the maximum weight which has been inserted, which may vary depending on the type of material used for the fillings (for the synthetic fibre up to at the most 8 g. and for the plumage up to at the most 5 g.).

7) Windows 126 (weighing operations counting) indicating how many weighing operations of the stuffing material have been effected.

8) Windows 127 (page manual controls) indicating the control for displaying the virtual page of the FIG. 12;

9) Windows alarms 128 indicating some alarm signals relating to the diagnostic of any defective operation or fault or operative defect of the machine program, by means of messages visual writings signalling into which components of the machine such malfunctions have been occurred, in order to eliminate such malfunctions and to restore the correct carrying out of each operative program. When any malfunction has been eliminated, under the condition in which the alarm has been disconnected, such alarm is prearranged again for operating in the case of subsequent malfunctions by acting on to the underlying push-button “alarm reset” 129.

10) Windows 130 (password) adapted to insert a password for entering some specific virtual pages for bringing extraordinary changes to the machine by the constructor only;

11) Windows reset parameters of default 131 indicating the restore of the standard values of the windows 120, 121, 122 and 123;

12) Windows “working hours” 132 indicating the number of hours of the machine operation;

13) Windows main page 133 indicating the touch sensitive selector for returning back to the main page 89.

14) Windows test 134 indicating the control for displaying the virtual page of the FIG. 13, where the operation conditions of the four loading cells are displayed;

15) Windows 135 indicating the control “cylinder accompanying the delay time”, below which the controls “ON” and “OFF” are inserted;

Such control 135, when the control “ON” is pressed, provides for letting a small windows (not shown) to appear sidewise, into which it is inserted manually the delay time employed by the bag to be filled with the stuffing material for being activated by the accompanying actuator (not shown), with respect to the moment of start of the filling process.

When the control “OFF” is pressed, such windows with the indicated time is lets to disappear.

There are now described three additional virtual pages visible on to the machine control panel 8, and comprising the page 136 (FIG. 12) relating to the machine manual controls, the page 137 (FIG. 13) relating to the tests to be effected in the case of operative defects of the machine, for displaying the weighing operation step for each single weighing balance, and the page 138 (FIG. 14) relating to the formula search.

In the page 136, the visible manual controls are the following:

139 indicating the control for opening and closing the valve 80 of the FIG. 6, in the case of operative defects of the machine; 140 indicating the restore control on to which to act, in the case in which a defined alarm message is put into evidence in the alarm windows 128 of the virtual page 91 of the FIG. 11;

141 indicating the controls for emptying manually each single weighing balance, which controls are numbered with the same number of the correspondent balance (in this case, from 1 to 4 from the upper to the lower part); 142 and 143: such controls have the same function as in the main page 89 (107 and 108); 144 indicating the control for displacing in the forward position the linear actuator 61 of the FIG. 6; 145 indicating the control for displacing in the backward position the linear actuator 61 of the FIG. 6; 146 indicating the push button to be pressed for returning back in the virtual main page of the FIG. 9; 147 indicating the push button to be pressed for returning back in the virtual page “parameters and diagnostic” of the FIG. 11; 148 indicating the push button to be pressed for going in the virtual page “test” of the FIG. 137, which will be described hereinafter.

The virtual page 137 indicates the tests for displaying the weighing operation step for the single weighing balances 1, 2, 3 and 4, indicated with the respective reference numerals 149, 150, 151, 152, while for each balance with 153 it is indicated the respective weighing operation step, with 154 it is indicated the programmed weight of the stuffing material to be weighed for each step, and with 155 it is indicated the detected weight of the stuffing material for each step; with 156 it is indicated the tare of the relative balance, with 157 there are indicated in progressive order from the upper to the lower part the relative weighing operation steps, and with 158 there are indicated the programmed weights for each weighing operation step, with 159 it is indicated the push button to be pressed for returning back to the virtual main page, with 160 it is indicated the push button to be pressed for returning back to the virtual page “parameters and diagnostic”, with 161 it is indicated the push button to be pressed for returning back to the virtual page of the manual controls, while with 162 and 163 there are indicated the respective push buttons which have the same function as in the main page 89 (107 and 108).

The virtual page 138 serves for displaying, when the push button “SEARCH FORMULA” 94 of the FIG. 9 is pressed, the virtual page into which there are displayed all the already programmed formula, which is selected among them by inserting the name of the formula which is desired to search in the frame 165. Once having been inserted, one presses the search push button 164 and the formula which has been found will be displayed in the windows 168, and the subsequent formula will be found from the list of the programmed formula, and the formula will be displayed also in the initial part of the windows 169, into which there are also indicated the programmed weights for the relative weighing operations steps; with 170 it is finally indicated the push button to be pressed for returning back in the main page.

Finally, returning back to the FIG. 4, it is described in short how each injection step of the stuffing material into the pocket or space of each clothes article is started and terminated. To this aim, the operator 171 arranges himself in front of the injector 83 of the injection station 7 of the machine and, when the stuffing material has been loaded into the inner components of this station as previously described, the machine is ready for the injection, and this condition is signalled by a pilot lamp (not visible). At this point, the operator 171 grasps the clothes article to be stuffed and arranges a relative pocket or space to be filled with this material in front of the injector 83, and introduces this latter fully within such pocket or space. Then, the operator 171 pushes the pedal for the injection start (the pedal isn't visible), so that the linear actuator 61 is actuated, which actuator finds itself in the position of the FIG. 7 c), so as the linear actuator 61 is advanced up to the position of the FIG. 8 c), thereby pushing all the stuffing material completely into the pocket or space, which is fully filled in an homogeneous and constant manner. Thereafter, while the main control device of the machine provides for stopping the advancement of the linear actuator 61 and for returning back this latter in the starting rest position thereof, for the carrying out of a subsequent injection cycle in the same way. These operative steps have been already described previously with reference to the FIG. 8.

1. Automatic machine for inserting in an homogeneous and metered manner into stuffed articles of various kind, in particular but not exclusively clothes articles, of stuffing material of various kind such as for example polyester fibres, plumage and the like, adapted to maintain the heat into the same articles, comprising a collecting and stocking container (5) of the stuffing material, adapted to contain the stuffing material (40) being picked up by means of transfer means (33, 36) from bags or containers provided by the producing and transforming firms of the same material, the machine comprising also weighing containers (45) communicating with said container (5), and loading cells (53) of the stuffing material loaded into the weighing containers (45), for weighing the quantities of the stuffing material to be inserted into the pockets or spaces (85) of each clothes article, comprising injection means (injection station 7) of the stuffing material into the pockets or spaces of each clothes article, and a control panel (8) including a main control device connected in the machine electric circuit and adapted to set, control and survey the different operative programs of the machine, and wherein said collecting and stocking container (5) is constituted by an upper chamber (19) and an underlying lower chamber (20), communicating to each other and enclosed and supported on the upper part of a metallic vertical structure (9), which is projected downward for forming a lower part supported on to the floor by vertical legs (22, 23, 24, 25), wherein said weighing containers (45) communicate at the lower part with said lower chamber (20) and are adapted to collect and weigh the stuffing material fallen from said lower chamber (20), in such metered quantities as to fill a pocket or space at a time of each clothes article, wherein said loading cells (53) are each one formed by at least an electric or electronic sensor, a balance or the like, disposed below the relative weighing container (45) of the machine and adapted to detect the weight of the stuffing material contained into the same container, and to generate correspondent electric or electronic signals corresponding to the weight which has been detected from time to time, which signals are transmitted through the machine electrical circuit toward said main control device, which provides for recognizing the same signals and indicating the correspondent weight which has been measured, and the so weighed quantity of stuffing material contained into each weighing container (45) is transferred from this latter toward said injection station (7) for being introduced into the pockets or spaces of each clothes article.

2. Automatic machine according to claim 1, wherein such support structure (9) is of quadrangular shape and extends for a determinate height and in its upper part is formed by a first pair of vertical flat walls, having the same height, which are spaced away and parallel to each other and joined by angular section bars joined to each other, which walls comprise a front wall (10) in which a transparent glass wall (11) having rectangular shape is included, and a back wall (12), and such structure upper part is also formed by a second pair of vertical flat walls, having the same height, which are orthogonal to the previous walls, and comprise a right side wall (13) and a left side wall (14), and all these walls are joined with an upper closing flat wall (15), shaped like a filtering grating, and with a lower closing flat wall (16), thereby delimiting said upper chamber (19) and lower chamber (20) which are visible through said transparent front glass (11).

3. Automatic machine according to claim 2, wherein said upper chamber (19) and lower chamber (20) are subdivided to each other by a horizontal separating inner plane (18), into which a vertical through hole (41) is provided, which puts into communication both the chambers (19, 20), and in the interior of said chambers (19, 20) a vertical rotating shaft (21) is provided, which is supported in the upper part by a reduction gear mounted in the central part of said upper filtering grating (15), and extends for the entire height of both the chambers (19, 20), and is supported in the lower part by a bearing mounted in central part of the lower closing wall (16) of the machine.

4. Automatic machine according to claim 3, wherein said vertical rotating shaft (21) is actuated in rotation and agitated in a fixed rotation direction and with a slow and continuous rotation speed by an agitator motor (32), mounted on and secured to the central part of the upper filtrating grating (15), and supplied by an electric cable, as well as positioned coinciding with the rotating vertical shaft (21), to which it is connected through the relative reduction gear, and wherein on to said rotating shaft (21) it is secured a thin horizontal rectilinear blade (39) in the upper chamber (19) and a further horizontal rotating blade (42) in the lower chamber (20), which blades (39 and 42) during their rotation provide for a continuous agitation of the stuffing material contained into the same chambers, and a progressive fall of the same material, at first from the upper chamber to the lower chamber, through said vertical through hole (41), and then from the lower chamber to the relative weighing containers (45) of such material, by passing through a relative trapdoor (49) arranged in a position overlapped to and coinciding with each relative weighing container (45).

5. Automatic machine according to claim 4, wherein each trapdoor (49) is preferably of rectangular shape and is arranged in a position interposed between the upper cylindrical part (46) of each weighing container (45) and a relative through hole provided through said lower closing wall (16), wherein the upper wall of each trapdoor (49) is open and into closer contact with the relative through hole of said lower closing wall (16), while the lower wall of each trapdoor (49) is also open and passes through a correspondent through opening of the upper cylindrical part (46) of the relative weighing container (45), entering slightly the same container, each trapdoor (49) being provided with movable means such as for example two pistons and two gates disposed closer to the open upper wall of the trapdoor (49), in a position aligned to each other and which can be actuated by means of the relative pneumatic cylinders (50, 51) or the like, connected in the machine pneumatic circuit and controlled by the software system incorporated into said control panel (8), such pistons and gates being able to be actuated from a closed position in which they are into contact between them and prevent the passage by fall of the stuffing material from the lower chamber (20) to the trapdoor (49) and from this latter into the relative weighing container (45), to an opened position in which the pistons and the gates are moved away from each other and allows the passage by fall of the stuffing material in the relative weighing container (45), by passing through the trapdoor (49).

6. Automatic machine according to claim 1, wherein said transfer means (33, 36) of the stuffing material are substantially constituted by at least a conventional exhaust fan (33), and by a lengthened flexible conduit (36) for sucking and passing the stuffing material, said exhaust fan (33) being mounted on and secured in the upper part to one of the machine side walls (13) and provided with an air outlet hole (35) and a sucking pipe fitting (34), and said lengthened flexible conduit (36) being introduced with its upper end portion (37) through a correspondent through hole of the back wall (12) of the vertical support structure (9) of the machine, therefore being supported by such back wall, in a manner that under the normal condition such conduit (36) be freely and vertically swinging along the same back wall, for almost its height, and the upper end portion (37) of the conduit (36) terminates in the interior of said upper chamber (19), and being connected to the sucking pipe fitting (34) of the exhaust fan (33), in a manner that when it is necessary to transfer the stuffing material from a bag or container, the lower end portion (38) of the conduit (36) be introduced into the bag or container of the stuffing material and, by actuating said exhaust fan (33), the stuffing material be sucked and let to pass through the entire conduit (36) and introduced into the machine upper chamber (19), and at the end of this suction the operation of the exhaust fan (33) be stopped, thereby arranging the machine for carrying out the operative cycles for introducing such stuffing material into the various containing pockets or spaces of the different clothes articles.

7. Automatic machine according to claim 1, wherein said weighing containers (45) are identical and spaced away from each other, with an uniform distribution on to the horizontal support plane (43) secured along the vertical legs (22, 23, 24, 25), each container (45) being shaped with an upper cylindrical part (46) having larger diameter, which is tapered downward by forming a lower cylindrical part (47) having smaller diameter, in a manner that the stuffing material loaded in an independent manner in the upper cylindrical part (46) goes down easily downward, by sliding along the inclined cylindrical wall (48) of the container, up to arrive in the lower cylindrical part (47).

8. Automatic machine according to claim 7, wherein said electric or electronic sensors, balance or the like of the loading cells (53) are calibrated in advance, by acting on the machine control panel (8), with the respectively desired quantities of the stuffing material for each weighing container (45), said loading cells (53) being connected to the relative pneumatic cylinders (50, 51) of the respective trapdoors (49), in a manner that, at the beginning of the weighing operation, they control the pneumatic cylinders (50, 51) in a way to open the trapdoor (49), for the entire duration of loading the material into the relative weighing container (45) and that, at the end of each loading, they control the pneumatic cylinders (50, 51) in a way to close the trapdoor (49), by terminating the filling of the relative weighing containers (45).

9. Automatic machine according to claim 8, wherein each weighing container (45) is communicating with an underlying collector (54), arranged on to a relative loading cell (53) and secured frontally to a relative air bellows (52), which collector is connected through a correspondent conduit (56), intercepted by pneumatic control valves connected to a pneumatic circuit of the machine and controlled by the main control device, with a central collector (57) mounted into the injection station (7) of the machine, in order to convey the weighed stuffing material and falling into the collector (54), from the relative weighing container (45) toward said central collector (57), with the aid of the correspondent air bellows (52).

10. Automatic machine according to claim 9, wherein said injection station (7) comprises a lengthened rectilinear tubular conduit (59), which extends in the axial and central direction of both the injection station (7) and the free space delimited by the different foreseen weighing containers, which conduit (59) is lengthened from a back side wall (14) of the machine up to the transversal terminal wall (60) of the injection station (7), and in to the same conduit there are included some components constituted by:
1) a lengthened rectilinear linear actuator (61), having cylindrical section with reduced thickness,
2) a filling collector (65) having tubular shape,
3) a flow amplifier (71),
4) a lengthened rectilinear perforated cylindrical reservoir (75).

11. Automatic machine according to claim 1, wherein said linear actuator (61) is housed into a lengthened piece (62) fixed between the weighing containers (45), and slidable in the alternate direction into the same piece, such actuator being fixed with an end portion thereof to an electric motor (63) connected to the machine electric circuit and provided for actuating the actuator in the alternate longitudinal direction, which motor (63) is controlled by the machine main control device, while the other end portion of the linear actuator (61) is shaped with an enlarged disc (64), said actuator (61) being adapted to slide from a retracted position thereof, in which the stuffing material finds it in the loading step into the weighing containers (45), and has not yet been introduced or has just been introduced into the components housed into the tubular conduit (59), to a working position thereof fully extracted from the tubular conduit (59), for injecting the stuffing material into the pockets or spaces (85) of each clothes article.

12. Automatic machine according to claim 11, wherein said filling collector (65) is adapted to introduce the stuffing material coming from the central collector (57) into an inner cavity (66) of the tubular conduit (59), provided in front of the linear actuator (61) displaced in the rest position thereof, and from such inner cavity (66) into the lengthened cylindrical reservoir (75), said filling collector (65) being shaped with a short tubular conduit (67), passing orthogonally through the peripheral wall (68) of the tubular conduit (59) and communicating with its internal end portion (69) with the inner cavity (66) and joined with its external end portion (70) with the central collector (57) through a conduit (58).

13. Automatic machine according to claim 12, wherein said flow amplifier (71) is constituted by a short tubular conduit (72), having a section smaller with respect to said tubular conduit (67) and passing orthogonally through the peripheral wall (68) of the tubular conduit (59) and communicating with its inner end portion (73) with the inner cavity (66), at a position closer to the previous tubular conduit (67), downstream the linear actuator (61) in its sliding direction A during the injection step of the stuffing material, such tubular conduit (72) being joined with its outer end portion (74) to a compressed air supply line of the machine, in such a way that when the compressed air is supplied through the tubular conduit (72), this latter provides for a correspondent suction of the air through the tubular conduit (67), which owing to the Coandà physical effect as operation principle of the flow amplifier, increases the air flow rate, namely for each unit of sucked air it is created a final multiple air flow rate, and wherein the so produced air suction provides for a consequent greater suction force of the stuffing material from the collector (54) of the weighing container (45), and such material be conveyed at first into the central collector (57), by passing through the relative conduit (56) the pneumatic valve of which has been actuated into the opened position, and thereafter from this central collector (57) the same material be conveyed into said inner cavity (66), by passing through the conduit (67), and from such inner cavity (66) the material be conveyed into the subsequent lengthened perforated cylindrical reservoir (75), with consequent arranging of the machine for the injection of the stuffing material into the pockets or spaces of the clothes article, with the linear actuator (61) displaced into the retracted rest position thereof.

14. Automatic machine according to claim 13, wherein said lengthened rectilinear perforated cylindrical reservoir (75) has an end portion (76) arranged into the inner cavity (66) and the other movable end portion (77) situated slightly spaced away from the terminal flat wall (78) of the tubular conduit (59), said cylindrical reservoir (75) being provided for the entire length thereof with a perforated surface, and an inner through hole having a diameter slightly larger than the disc (64) of the linear actuator (61), in order to allow the alternate sliding of this latter, in a way that during the injection step the disc (64) of the actuator (61) by sliding through such inner through hole pushes progressively the sucked stuffing material along the entire cylindrical reservoir (75), up to the end portion (77) of the same reservoir, which end portion is kept closed, and wherein the duration of the loading step of the stuffing material into the cylindrical reservoir (75) occurs within a pre-established time, which may be changed depending on the type of stuffing material and its quantity, and such duration is controlled by the main control device and is set by the constructor.

15. Automatic machine according to claim 14, comprising an intercepting valve (80) mounted in the interior of the tubular conduit (59), in a position comprised between the relative end portion (77) of the cylindrical reservoir (75) and the terminal flat wall (78) of the same tubular conduit, such valve (80) being connected in the machine electrical circuit and controlled by said main control device, from an opened position to a closed position thereof, and vice versa, said valve (80) being also connected with said terminal end portion (77) and, when it is actuated in the closed position thereof, it remains in this position by keeping closed also the terminal end portion (77), and under this condition the stuffing material may be loaded into the cylindrical reservoir (75) up to the closed terminal end portion (77).

16. Automatic machine according to claim 15, comprising an electronic sensor (81), connected to a timer in the injection station (7), which is connected in the machine electrical circuit, and adapted to produce a message of “injection OK” when the stuffing material is arrived at the adjacent end portion of a hollow injector (83).

17. Automatic machine according to claim 16, wherein said hollow injector (83), external to the tubular conduit (59), is formed by a rectilinear pipe disposed in a position aligned and coincident with the through hole (82) of the tubular conduit (59) and has the same diameter of the cylindrical reservoir (75), such hollow pipe (83) being joined to a short cylindrical conduit (84) into which said valve (80) is housed, and is joined to the end portion (77) of the cylindrical reservoir (75), by passing through the through hole (82), and being slightly projected outward the tubular conduit (59), said hollow injector (83) being provided for injecting the stuffing material into a pocket or space (85) of a clothes article.

18. Automatic machine according to claim 1, wherein at the end of the time regulated loading step of the stuffing material (40) into the cylindrical reservoir (75), this condition is detected by the main control device of the machine, which provides for actuating both the valve (80) into the opened position thereof and the electric motor (63), and therefore the linear actuator (61) too, in the advancing direction A with a continuous advancement, and the start of the advancement of the linear actuator (61) is established after that the determined time for filling the reservoir (75) is elapsed, and the passage of the material through the through hole (82) of the tubular conduit (59) is detected by the electronic presence sensor (81), which signals such presence of the material to the main control device of the machine, and wherein when the linear actuator (61) has pushed the stuffing material (40) along the injector (83) up to the end portion of the same injector, under the condition in which the stuffing material has filled the pocket or space (85) of the clothes article, said sensor (86) controls the back movement of the linear actuator (61) into its starting rest position, which is detected by the same sensor, and the machine is so arranged for performing a subsequent injection cycle of the stuffing material into another pocket or space of the clothes article referred to or of another clothes article.

19. Automatic machine according claim 1, wherein for starting and terminating each injection step, the operator (171) arranges himself in front of the injector (83) of the injection station (7) and, when the stuffing material has been loaded into the inner components of this station (7), the machine is ready for the injection, and this condition is signalled by a pilot lamp, so that at this point the operator (171) grasps the clothes article to be stuffed and arranges a relative pocket or space (85) to be filled with this material in front of the injector (83), and introduces this latter slightly within such pocket or space (85), then the operator (171) pushes the pedal for the injection start, so that the linear actuator (61) is actuated, up to the material has been completely pushed into the pocket or space (85), and subsequently the operator (171) releases the start pedal, and under this condition the linear actuator is stopped and returns back in the starting rest position thereof.
